(19) United States
(12) Patent Application Publication
(10) Pub. No.: US 2026/0148108 A1
(43) Pub. Date: May 28, 2026

(54) METHOD AND DEVICE FOR GENERATING A LOGIC-BASED EVALUATION RESULT

(71) Applicant: FORBENCAP GmbH, Sonthofen (DE)

(72) Inventor: Stefan M GÖTZ, Forstern (DE)

(21) Appl. No.: 19/395,164

(22) Filed: Nov. 20, 2025

(30) Foreign Application Priority Data
Nov. 25, 2024 (DE) 10 2024 134 656.6

(51) Int. Cl. G06N 5/04

(52) U.S. Cl. CPC G06N 5/04

(57) ABSTRACT

A method for generating a logic-based evaluation result for an automated subsumption of a life situation, in particular under applicable legal norms. The steps may include: providing data documenting the facts of the case, the data comprising at least textual, pictorial, natural and/or other evidence; processing the provided data by a machine learning model to extract relevant information from the data and to present it in a structured form; matching the structured information with legal norms and/or requirements by a logic network that draws logical conclusions based on the extracted information and the legal requirements; assessment of the life situation by subsuming the extracted information under the applicable legal norms based on the results of the logic network; and output of an assessment result that includes an assignment of the life situation to the legal norms.

### CROSS-REFERENCE TO RELATED APPLICATION(S)

This application claims the benefit of German Application No. DE 10 2024 134 656.6, filed Nov. 25, 2024, which is incorporated herein by reference in its entirety.

### TECHNICAL FIELD

The present invention relates to the technical field of automated analysis and legal evaluation of life facts on the basis of evidence in textual, pictorial, natural or other forms. In particular, the invention relates to methods and devices that support the subsumption of a documented life fact under applicable legal norms.

### BACKGROUND

The state of the art currently involves manual processes in which humans sift through evidence, identify the relevant facts and compare them with legal requirements. However, this approach is time-consuming, prone to error and reaches its limits in the constantly changing legal landscape. Case law and legal norms are continuously being adapted, expanded or reinterpreted in order to align with national, regional or international standards. This means that updates are often not available to users in time or in full.

Insufficient consideration of new or amended standards can lead to factual circumstances being incorrectly subsumed and, as a result, incorrectly evaluated. These incorrect evaluations can have serious negative legal consequences, especially if decisions are based on erroneous legal evaluations.

Modern machine learning models, in particular language models or multimodal models, offer promising approaches for the automated analysis of text and image information. Nevertheless, these models have significant limitations because they work on a probabilistic basis and cannot draw logical conclusions. This is a significant obstacle because the subsumption of legal norms requires not only the analysis of information but also the establishment of logical connections and the comparison with legal requirements.

### SUMMARY

It is an object of the invention to indicate an improved method and/or an improved device for this purpose.

The problem is solved by a method according to the features of claim 1. The problem is solved by an apparatus according to the features of claim 10.

According to a preferred aspect, a method for generating a logic-based evaluation result for an automated subsumption of a life circumstance, in particular under applicable legal norms, is proposed. The method involves the provision of data documenting the facts of the case, which may be available in a variety of formats, including text, image, natural and/or other evidence. This ensures that a wide range of documentation types can be taken into account, which increases the flexibility and applicability of the method.

Another feature of the method is the processing of the provided data using a machine learning model. This model is designed to extract relevant information from the data and present it in a structured form. This enables the efficient and precise analysis of large amounts of data, even if they are unstructured or multimodal. The use of machine learning models ensures that even complex data formats such as combined text-image documents or natural evidence can be made accessible through automated processes.

A logic network then compares the structured information with legal norms and/or requirements. This is designed to draw logical conclusions based on the extracted information and the applicable requirements. Compared to purely machine-based learning models, the logic network enables more precise and comprehensible processing because it uses dedicated reasoning mechanisms based on defined rules or ontologies. The integration of a logic network addresses the weakness of purely probabilistic models, which cannot map explicit logic.

A further step in the process is the evaluation of the life situation by subsuming the extracted information under the applicable legal norms, based on the results of the logic network. This evaluation enables a systematic and consistent assignment of the facts to the norms. The structured combination of the data from the machine learning model and the conclusions of the logic network achieves a higher level of accuracy in the evaluation.

The output of the evaluation result includes an assignment of the life situation to the legal norms. In addition, indications of relevant legal changes or uncertainties can be given. This function ensures that current developments in the legal situation are also incorporated into the evaluation, which increases the timeliness and relevance of the process.

The procedure can be extended to allow the logic network to be dynamically adaptable. This would allow new rules or ontologies to be automatically integrated, for example by processing updates in standards databases or other sources. Furthermore, an iterative feedback loop could be introduced between the machine learning model and the logic network to continuously improve the relevance of the extracted information and minimize uncertainties.

Evidence preferably includes all information and materials that are suitable for documenting or illustrating a factual situation, regardless of their form, medium or origin. This preferably serves as a basis for automated analysis, subsumption and legal evaluation. This includes primarily textual evidence such as written or digital documents, for example contracts, invoices, reports, e-mails, court rulings, legal texts, as well as notes or handwritten records that may have been digitized using optical character recognition. Furthermore, evidence preferably includes pictorial information, such as photographs depicting scenes, objects or events, graphics, plans or diagrams, as well as video recordings documenting motion pictures or sequences. Natural evidence preferably includes voice input such as recorded conversations or voice logs, as well as audio data with relevant acoustic information, for example statements or ambient noise. In addition, other evidence can preferably be used, such as digital artifacts such as metadata, location data or time stamps associated with an event, or sensory data from devices such as GPS, thermometers or surveillance systems. Evidence may preferably include combinations of different types, such as text in conjunction with associated images or videos. It preferably comes from different sources, including digitized paper documents, digital-native documents from databases, social media or public platforms, and internal or external files. This evidence is preferably processed, structured and converted by the technical solution of the invention into a form that enables logical subsumption under applicable legal norms.

A set of facts refers preferably to the totality of the factual circumstances and events that are related to a legal issue and are to be legally evaluated. It preferably includes all relevant facts, actions, conditions and/or developments that may have either a direct or indirect significance for the application of a legal norm. A life situation thus preferably forms the basis for legal subsumption, in which it is examined whether and how the legal requirements can be applied to the specific case. Typically, a life situation is made up of various elements, such as the persons or institutions involved, the course of action or events, the temporal and local circumstances, and the associated evidence documenting the circumstances. A matter of fact can be recorded using textual, pictorial, natural or other evidence that contains relevant information and helps to clarify the matter. In a legal context, the matter of fact serves as a starting point for examining whether the established facts fulfill the requirements of a legal norm and what legal consequences arise from them. Complex life circumstances that touch on several legal aspects may require a comprehensive and structured analysis in order to consider all relevant facts with regard to the applicable norms.

The technical advantages of the method lie particularly in the automation and acceleration of processes that previously had to be carried out manually. The combination of machine learning and logic networks enables more precise and comprehensible subsumption, even in complex life circumstances. The flexibility in processing multimodal data ensures a broad applicability of the method, while the possibility of automatically taking legal changes into account increases the timeliness and quality of the results. In addition, the integration of a structured presentation of the results ensures that the evaluations can be reproduced by users, which is of crucial importance in legal or normative contexts.

Firstly, the use of a machine learning model for the structured processing of data, including unstructured or multimodal formats, provides a technical solution to the problem of efficiently analyzing and interpreting complex and heterogeneous data sets. Secondly, the integration of a logic network that draws logical conclusions based on extracted information and applicable legal norms enables a precise and comprehensible assessment that purely probabilistic models cannot provide. This represents a technical advance because it overcomes the model limits and ensures systematic subsumption. Thirdly, the dynamic adaptability of the logic network through the integration of current normative changes improves the timeliness and relevance of the results, which in a technical context ensures the long-term functionality and maintainability of the system. Fourthly, the automation of previously manual processes results in a significant reduction in time and error-proneness, which is a technical contribution to the optimization of workflows. Finally, the structured output of the evaluation results, including the consideration of legal changes, leads to improved user-friendliness and traceability.

It is understood that the steps of the invention, as well as further optional steps, do not necessarily have to be carried out in the order shown, but can also be carried out in a different order. Furthermore, further intermediate steps can be provided. The individual steps can also comprise one or more sub-steps without leaving the scope of the method according to the invention.

According to a preferred aspect, a device is proposed for generating a logic-based evaluation result for an automated subsumption of a life situation, in particular under applicable legal norms, wherein the device has an evaluation and computing unit that is designed to carry out the following steps: providing data documenting the life situation, wherein the data includes at least textual, pictorial, natural and/or other evidence; processing the provided data by means of a machine learning model to extract relevant information from the data and to present it in a structured form; matching the structured information with legal norms and/or requirements by means of a logic network that draws logical conclusions based on the extracted information and the legal requirements; assessment of the life situation by subsuming the extracted information under the applicable legal norms based on the results of the logic network; and output of an assessment result that includes an assignment of the life situation to the legal norms, as well as optional information on relevant legal changes or uncertainties.

The explanations given for the method apply accordingly to the device. It is understood that linguistic modifications of features formulated in procedural terms can be reformulated for the device in accordance with customary linguistic practice, without the need to explicitly list such formulations here.

The procedure and the device offer a further development and optimization of previous language models in order to achieve a higher accuracy and transparency. This makes it possible, for example, to make a previously often manual process of checking in the legal field and/or in international and national standardization and/or form processing more efficient by using the improved language model structure, thus minimizing errors if necessary. In addition, the at least one language model used can be used to integrate changes in legislation and/or changes in the standardization review and/or standards review into a review scheme faster and more precisely and/or to adapt a review scheme accordingly, which can facilitate the transition process for new legislation.

According to a further aspect, a method is proposed in which the machine learning model has a multimodal model that processes text, image and/or further evidence, in particular simultaneously, and provides the data in an integrated, structured representation for subsumption.

The method uses a machine model that is specifically designed to process and combine different data formats in order to enable a holistic analysis of the facts of the case.

A preferred feature of the method is the multimodal processing of the data. The machine learning model can preferably analyze textual data, such as documents or e-mails, and image data, such as photographs of evidence, simultaneously. This capability allows the different aspects of a case to be considered in a single processing step, rather than having to analyze the data separately and combine it later. This results in more efficient and coherent processing.

Another feature is the simultaneous processing of the various data formats. This means that text, image and other types of data are processed in parallel, reducing time delays. Advanced neural network architectures are preferably used here, which are able to analyze different data streams simultaneously and establish links between the data. This makes it possible, for example, to combine text content with visual information from images and interpret them together.

Another technical feature is the integrated, structured representation of the processed data. The machine learning model preferably generates a unified structure from the various data sources, which is optimized for further processing, especially by the logic network. This structured representation enables precise subsumption, since the relevant information is provided in a standardized form.

The method can be extended by integrating additional data types, such as acoustic or sensory data, to enable an even more comprehensive analysis. Further optimization could consist of using specialized neural network modules for certain data formats, which are then combined in a higher-level model. In addition, the model could be trained dynamically to adapt to new types of evidence, for example by using transfer learning techniques.

The technical advantages of the method lie in its ability to precisely analyze complex factual circumstances by simultaneously processing different data formats. The multimodal and simultaneous processing saves time and resources and increases the accuracy of the data analysis. The integrated, structured representation optimally prepares the data for subsumption, thereby improving the overall performance of the system. This leads to greater efficiency and reliability in the evaluation of factual circumstances.

According to a further aspect, a method is proposed in which the logic network is based on an ontology that maps legal terms, relationships and/or hierarchical structures, and the subsumption is supported by semantic inference methods.

This method uses an ontology to systematically represent complex legal relationships and normative structures and to draw logical conclusions from them.

A key feature of the procedure is the use of an ontology that maps legal terms and their relationships. An ontology is a structured knowledge base that defines terms and describes their interrelationships. For example, legal terms such as “contract”, “termination” or “compensation” and their hierarchical and semantic relationships can be captured. This makes it possible to make legal norms and terms accessible to the logic network in their logical structure.

Another feature of the process is the mapping of hierarchical structures in the ontology. Preference is given to taking into account legal generic and specific terms as well as their context, such as the relationship between a general principle and a specific rule. This is particularly important for subsumption, as it allows complex dependencies between general norms and specific exceptions to be correctly taken into account.

Another technical feature is the support of subsumption by semantic inference methods. These methods use the ontology to draw logical conclusions that go beyond a mere analysis of the provided data. For example, semantic inference can be used to derive additional information, such as the identification of relevant exceptions or the application of special regulations that are important in the context of the facts of the case.

The process can be expanded by regularly updating the ontology with new terms, rules or standards in order to adapt it to changing legal conditions. One possible optimization is also the automatic expansion of the ontology through machine learning processes that derive new connections from legal texts. In addition, advanced semantic algorithms could be used that analyze and take into account multidimensional dependencies between legal terms.

The technical advantages of the method lie particularly in the precise and systematic modeling of complex legal relationships. The use of an ontology ensures that subsumption is carried out on a clearly defined and comprehensible basis. The semantic inference procedures increase the accuracy of the subsumption because they can recognize implicit relationships and dependencies. This improves the efficiency and reliability of the process, especially when processing life situations that involve complex legal structures.

According to a further aspect, a procedure is proposed in which the logic network is dynamically adaptable and/or integrates new rules and/or ontologies, in particular automatically, from amended legal requirements and/or standards.

This procedure ensures that the logic network can react flexibly to changes in the legal framework without the need for manual adjustments and without the machine learning model necessarily having to be retrained.

A key feature of the procedure is the dynamic adaptability of the logic network. This means that the logic network is able to modify existing rules or ontologies and add new ones when legal requirements or standards change. Preferably, this adaptation is done by automated processes that identify changes in relevant data sources, such as legal databases or judgment portals, and integrate the corresponding information into the logic network. This ensures that the network is always up to date and takes into account current legal standards.

Another technical feature is the automatic integration of new rules and ontologies. Here, the system analyzes external sources to identify changes or additions to legal norms and incorporates these into the existing structures of the logic network. For example, new legal requirements can be automatically extracted by parsing algorithms and machine learning processes and incorporated into the network's ontology. This significantly reduces the manual effort required to maintain the network.

Another feature is the ability to seamlessly integrate amended legal requirements into existing subsumption processes. This is achieved by means of a flexible logic network architecture that makes new rules or standards immediately applicable without affecting existing processes or results. Versioning systems are preferably used to keep different legal statuses available for specific use cases.

The process can be extended by integrating additional data sources such as international legal databases or industry-specific regulations. A further optimization could be to supplement the automatic updates with a quality assurance component that checks the consistency and correctness of the added rules or ontologies. In addition, the logic network could be combined with machine learning models that predict changes in legal texts and thus proactively enable adjustments.

The technical advantages of this procedure are, in particular, the flexibility and up-to-dateness of the logic network. The dynamic adaptability ensures that changes in legal requirements are immediately taken into account, which increases the reliability of the subsumption processes. The automatic integration of new rules reduces the effort required for manual updates and minimizes the risk of using outdated standards or rules. This leads to greater efficiency and accuracy in the assessment of life facts and makes the system future-proof against constantly changing legal requirements.

According to a further aspect, a method is proposed in which the interaction between the machine learning model and the logic network takes place through a feedback loop that assesses the relevance of the data extracted by the machine learning model and iteratively refines the processing.

This feedback loop forms a bidirectional connection between the machine learning model and the logic network, which allows the extracted data to be continuously analyzed and optimized. The logic network uses the structured data from the machine learning model, evaluates its relevance in the context of legal norms, and provides feedback that prompts the machine learning model to further improve the extraction.

One preferred feature is the evaluation of the relevance of the extracted data. This is done by the logic network, which uses its ontologies, rules and/or inference algorithms to analyze the meaning and context of the information in the context of the legal requirements. This ensures that irrelevant or redundant information is recognized and excluded. At the same time, missing information that is required for a complete subsumption can be identified.

Another feature is the iterative refinement of the data processing. The machine learning model adjusts its extraction strategies based on feedback from the logic network. This can be done, for example, by adjusting the weighting of relevant features or by reprocessing specific data areas. This iteration continuously improves the quality of the structured data, thereby increasing the accuracy of the subsumption.

The process can be enhanced by combining the feedback loop with a confidence assessment system. This system could define thresholds that trigger further iteration of the data processing only if the confidence in the relevance of the extracted data is below a certain level. A further optimization could be the integration of a machine learning model that is specifically trained to efficiently interpret and apply the feedback from the logic network, thereby increasing the speed of the iterations.

The technical advantages of this procedure consist in particular in the dynamic adaptation and continuous improvement of the data processing. The feedback loop ensures that only relevant and precise data is used for the subsumption, which increases the accuracy of the legal assessments. In addition, iteration allows for flexible adaptation to complex or incomplete life circumstances. This reduces the risk of incorrect subsumptions and improves the efficiency of the entire process by avoiding unnecessary calculations.

According to a further aspect, a method is proposed in which the logic network uses inference algorithms to take into account dependencies and exceptions within the legal norms, and in particular enables a more precise evaluation of complex life circumstances.

The procedure combines the ability to analyze legal structures with advanced algorithms that can recognize and evaluate complex logical relationships between norms.

A key feature of the procedure is the use of inference algorithms. These algorithms are designed to draw logical conclusions based on the defined rules, ontologies and provided data. In doing so, they not only recognize direct connections between pieces of information, but also implicit relationships, such as the application of specific exceptions or dependencies between different legal requirements. Algorithms that support both forward and backward reasoning are used to comprehensively analyze the relevance of the information.

Another technical feature is the consideration of dependencies within the legal norms. These dependencies can, for example, take the form of conditions or requirements that influence or complement each other. The process makes it possible to precisely model such relationships and include them in the evaluation, ensuring that no important aspects of the legal context are overlooked.

Another feature is the recognition and handling of exceptions within the standards. In many legal frameworks, there are exceptions that apply under certain circumstances and can significantly influence the subsumption. The logic network is able to identify and correctly apply such exceptions, thereby significantly increasing the accuracy and reliability of the evaluation.

The process can be extended by combining the inference algorithms with machine learning models that can recognize patterns and frequencies in the application of dependencies and exceptions. Further optimization could include the integration of uncertainty models that enable probabilistic decisions when data is incomplete or contradictory. Additionally, supplementary legal data sources could be used to create a broader basis for recognizing dependencies and exceptions.

The technical advantages of this method lie particularly in its ability to precisely analyze and evaluate complex legal structures and their interactions. The use of inference algorithms ensures that even complicated exceptions and dependencies are correctly taken into account, making the subsumption results more accurate and reliable. In addition, the efficiency of the process is increased because many of the logical relationships that would otherwise have to be checked manually are automatically recognized and processed. This makes the procedure extremely effective, especially when analyzing complex life circumstances.

According to a further aspect, a procedure is proposed in which the subsumption result outputs a structured evaluation in the form of a logical explanation that comprehensibly presents the derivation steps between the extracted information and the legal norms.

The procedure ensures that the results of the subsumption are documented transparently and comprehensibly so that users can understand the evaluation steps in detail.

One of the process's preferred features is the structured output of the subsumption result. The results are provided in a standardized form that shows clear links between the analyzed data, the applied standards, and the resulting conclusions. Preferably, a formatted report is generated that contains all relevant details of the subsumption, such as the identified legal norms, the applied exceptions, and the logical steps that led to the decision.

Another technical feature is the logical explanation of the evaluation results. The procedure documents the derivation steps carried out by the logic network during the subsumption process. This includes, for example, the application of specific rules or inference algorithms as well as the consideration of dependencies and exceptions. This ensures that every decision is supported by a comprehensible and verifiable justification.

Another feature is the traceability of the link between the extracted information and the legal norms. The procedure clearly shows how the data of the facts of the case were related to the applicable norms and which logical steps were taken into account. This makes it possible to check the relevance and validity of the evaluation results and to make adjustments if necessary.

The process can be enhanced by supplementing the structured output with visual elements such as diagrams or flowcharts to make complex logical relationships easier to understand. A further optimization could be the integration of an interactive user interface that allows specific derivation steps to be examined in detail or alternative scenarios to be simulated. In addition, quality controls could be integrated into the process to check the consistency and accuracy of the logical explanations.

The technical advantages of this procedure lie particularly in the transparency and traceability of the subsumption results. The structured and logical documentation ensures that the results are verifiable and trustworthy even in legally sensitive or complex contexts. In addition, the detailed explanation increases the acceptance of the automated subsumption, since users can fully understand the decision-making processes. This not only improves the quality of the evaluation, but also creates a basis for efficient communication and review of the results.

According to a further aspect, a method is proposed in which the logic network comprises a programmable logic array and/or a state machine, preferably with the state machine being designed as a Mealy or Moore structure, in order to execute logical conclusions by stepwise state transitions based on the extracted information and the legal norms. This method uses special hardware-or software-based structures to perform logical operations efficiently and traceably.

A key feature of the process is the use of a programmable logic array in the logic network. This array enables the flexible definition and implementation of logical rules and conditions that are applied to the extracted information. A programmable logic array offers the advantage that it can be dynamically adapted to different requirements, for example by updating the rule base when legal requirements change. This makes the system flexible and future-proof.

Another technical feature is the integration of a state machine. State machines work on the basis of defined states and perform logical operations through state transitions. Either a Mealy or a Moore structure is used. In a Mealy automaton, the output depends on the states and the inputs, while in a Moore automaton, the output depends only on the states. These structures make it possible to efficiently model and execute complex logical processes, such as the step-by-step application of rules and exceptions depending on the facts of the case.

Another feature of the method is the ability of the logic network to execute step-by-step state transitions based on the extracted information and legal norms. This enables the network to process logical processes in a clearly defined order, which is particularly advantageous for complex subsumption tasks. This structure ensures that the processing remains comprehensible and verifiable at all times.

The process can be extended by equipping state machines with adaptive elements that enable new states or transitions to be added automatically based on changes in the legal requirements. A further optimization could be the combination of programmable logic arrays with machine learning models to dynamically expand the rule base through data analysis. In addition, hybrid structures could be developed that combine the advantages of Mealy and Moore machines to increase the flexibility and efficiency of the process.

The technical advantages of this method lie particularly in the efficiency and precision of the logical conclusions. By using programmable logic arrays, the system can react flexibly to different requirements, while state machines enable structured and comprehensible processing. The step-by-step state transitions reduce the risk of errors and enable clear documentation of the subsumption processes. Furthermore, these structures improve processing speed and reliability, especially for complex or data-intensive applications. This makes the method particularly suitable for automated legal assessments where precision and traceability are of critical importance.

A programmable logic array (PLA) and a state machine (finite state machine, FSM) are preferably components in digital circuits and computer systems. A programmable logic array (PLA) is preferably a type of digital logic circuit that can be configured to perform various logic functions. A PLA preferably includes an array of programmable AND and OR gates. The key features of a PLA are the AND level, which preferably comprises a series of AND gates. Each input can be fed into the AND gates either directly or negated (inverted). This level makes it possible to generate product terms that represent combinations of the input variables. Furthermore, PLAs preferably include at least one OR level. The outputs of the AND level are preferably fed as inputs to a series of OR gates. This level combines the product terms to form the final logical expressions. Both the AND and OR levels are preferably programmable, meaning that they can be configured to perform specific logical functions and thus reflect, for example, a complex inspection scheme. This is preferably done by setting or deleting connections in the matrix.

A finite state machine (FSM) is a model of computation that consists of a finite number of states that can be transitioned between based on inputs and transition conditions. An FSM can be categorized into two main types: Mealy and Moore machines. A Mealy machine is an FSM in which the outputs depend on the inputs and the current state.

A Mealy automaton preferably has a finite number of states that the automaton can be in. A Mealy automaton preferably has rules that determine how the automaton transitions from one state to another based on the inputs. A Mealy automaton preferably has variables or signals that influence the state of the automaton. In a Mealy automaton, outputs are preferably calculated as a function of both the current state and the inputs.

A Moore machine is an FSM in which the outputs depend only on the current state. A Moore machine preferably has a finite number of states that the machine can be in. A Moore machine preferably has rules that determine how the machine transitions from one state to another based on the inputs. A Moore machine preferably has variables or signals that influence the state of the machine. In a Moore automaton, outputs are preferably calculated solely as a function of the current state.

In a digital circuit, PLAs and FSMs can be combined to implement complex control logics. A PLA can be used to generate the logical expressions that control the state transitions and outputs of an FSM. This enables a flexible and programmable solution for implementing control algorithms and other logical functions.

In a further aspect, a computer program product is proposed, comprising instructions that, when the program is executed by a computer, cause the computer to carry out the steps of the present method in one of its aspects.

The computer program product preferably comprises a collection of instructions written in one or more programming languages, and preferably designed to accomplish the tasks and/or functions described in the method when executed by a computer. The instructions in the program are preferably designed to cause the computer to step through and perform the various steps and operations of the method according to the aspects indicated.

In a further aspect, a computer-readable data carrier is proposed on which such a computer program product is stored.

This computer-readable data carrier can comprise various physical media, such as CDs, DVDs, USB sticks, hard disks or SSDs, which can be read by computers or similar electronic devices. The computer program product stored on the data carrier preferably comprises a collection of instructions or code that can be executed by a computer to perform specific functions or tasks. The program can be written in different programming languages and contain different components such as executable files, libraries, configuration files and documentation. The data carrier preferably enables the computer to read and execute the program stored on it in order to realize the intended functions.

The present method can employ various types of machine learning models. Preferably, transformer-based models, such as BERT, GPT or other large language models (LLMs), are used, which are specialized for analyzing and processing text data. For processing multimodal data, models such as CLIP or Vision-Transformer (ViT) can also be used, which can analyze both text and image data. Alternatively, convolutional neural networks (CNNs) can be used for image processing or recurrent neural networks (RNNs) for temporal data, depending on the requirements of the input data.

The logic network can take various forms, preferably as a rule-based system, ontology and/or as state-based logic such as a Mealy or Moore automaton. Furthermore, inference systems can be used that work with knowledge graphs or semantic models. For particularly efficient processing, the logic network can be implemented as a programmable logic array or in hardware-based solutions, such as field-programmable gate arrays (FPGAs).

The link between the machine learning model and the logic network is implemented at the software and/or hardware level. At the software level, the models can be integrated via APIs or specialized middleware that ensures smooth communication between the modules. At the hardware level, the link can be implemented using shared memory or specialized processors that support both machine learning models and logic networks. Preferably, a framework is used that allows seamless integration, such as TensorFlow, PyTorch or dedicated hardware accelerators.

The interaction between the machine learning model and the logic network takes place in several steps. First, the machine learning model processes the input data and extracts relevant information. This structured data is then passed to the logic network, which draws logical conclusions based on the defined rules, ontologies or state machines. The logic network can in turn provide feedback to the machine learning model to iteratively refine the data processing. At least one output of the logic network is preferably fed back as input to the input or to an intermediate stage of the machine learning model. Preferably, this interaction takes place in a bidirectional feedback loop. For example, at least one output of the logic network is passed as an input to the input or to an intermediate stage of the machine learning model and at least one output of the machine learning model is passed as an input to the input or to an intermediate stage of the logic network. The outputs can be temporally delayed before feedback, for example by at least one calculation cycle. Furthermore, data passed from the logic network to the machine learning model or from the machine learning model to the logic network can be an embedding or its inverse, for example as a mapping between numbers and a non-numeric system, for example linguistic elements or categories, among other things according to an embedding table or as a mathematical mapping.

One or more outputs of the machine learning model and/or the logic network can directly or indirectly form outputs of the process after further processing steps.

The data inputs consist, for example, of multimodal information such as texts, images or natural evidence. The outputs include structured assessments, logical conclusions and subsumption results, which are provided in the form of reports or machine-readable data. In addition, confidence assessments or uncertainty analyses can be integrated as part of the outputs.

For training the machine learning model and the logic network, training data is preferred that includes labeled facts, associated legal norms and correct subsumption results. This data can be generated from legal databases, court rulings, regulations and/or simulated scenarios. Training is preferably carried out in two phases: First, the machine learning model is preferably trained to extract relevant data, and then the logic network is trained with the rules and ontologies necessary for logical reasoning. The training sequence can also be reversed. Joint training, in which both modules are iteratively improved, is also possible. Furthermore, the logic network can also be provided ready-to-use and only the machine learning model is trained.

The training methods preferably include supervised learning, in which the models are optimized using labeled data sets, and transfer learning, in order to adapt pre-trained models for specific applications. For the logic network, rule-based approaches with manually defined rules or reinforcement learning can be used to optimize the state machines.

Online optimization can be achieved by continuously integrating new data from real-world applications. Preferably, a feedback mechanism is used that compares the system's results with actual evaluations and iteratively adjusts the models. In addition, active learning approaches can be implemented in which the system specifically requests new training data to close knowledge gaps.

The output of the evaluation result can take various forms, depending on the specific application and the requirements of the process. For example, it can be provided as a structured report that presents the results of the subsumption. The report could include the assigned legal norms, the relevant exceptions and dependencies, and a summary of the logical conclusions. Alternatively, the output can be provided in a machine-readable form, such as JSON, XML, or other data formats suitable for integration into downstream systems or processes. In addition, the output can include visual elements such as diagrams or decision trees to make complex logical relationships easier to understand. For interactive applications, the output can be provided via a user interface that allows specific details of the evaluation to be viewed or alternative scenarios to be simulated.

Reasoning can be used to further optimize the process by making the logical conclusions during the subsumption process comprehensible and consistent. This could be done by integrating inference algorithms that ensure that all relevant legal norms and their dependencies are fully taken into account. Furthermore, reasoning can be used to simulate alternative assessment paths in case of uncertainty and to compare their results, which increases the robustness and reliability of the process.

A confidence scoring can be used to assess the certainty and reliability of the subsumption results. This involves calculating a confidence value for each logical conclusion, indicating the probability that the conclusion is correct. Such values can be calculated based on uncertainties in the input data, the quality of the extracted information, or the complexity of the legal norms. A low confidence value can prompt the system to analyze additional data sources or consider alternative conclusions. Furthermore, confidence scoring can be used to prioritize the results by first presenting the most reliable subsumptions.

The process can be further optimized by combining reasoning and confidence scoring to dynamically decide when further iterations of data analysis or additional processing is required. Further optimization could be to integrate the confidence values into the output, enabling users to better assess the uncertainties and risks of the results. This not only increases transparency, but also the possibility of taking targeted action based on the results. Overall, these approaches lead to greater precision, reliability and adaptability of the process.

A specific example of an application is the automated evaluation of insurance claims. The machine learning model analyzes submitted documents such as damage reports, photos, and/or contract documents. The logic network checks whether the damage is covered by the insurance conditions, taking into account exceptions or specific clauses. The output includes a structured assessment of whether the case can be settled and optionally offers recommendations for improvements if information is missing. This procedure reduces processing times and ensures a consistent and legally sound assessment.

The aspects described and their further developments can be combined with each other in any way.

Further possible designs, further developments, aspects and/or implementations of the invention also have combinations of the features mentioned above or below that have yet to be explained, which have not been explicitly mentioned. In the present case, “one” is understood to mean “at least one”.

### BRIEF DESCRIPTION OF DRAWINGS

The accompanying drawings are intended to provide further understanding of the embodiments of the invention. They illustrate embodiments and, in the context of the description, serve to explain principles and concepts of the invention.

Other embodiments and many of the advantages mentioned arise with regard to the drawings. The illustrated elements of the drawings are not necessarily shown to scale in relation to each other.

FIG. 1 shows a schematic flowchart of an exemplary embodiment of the present method.

FIG. 2 shows a schematic view of an exemplary structure of a machine learning model, in particular a language model, extended by a logic network.

### DETAILED DESCRIPTION

In the figures of the drawings, the same reference signs denote the same or functionally identical elements, parts or components, unless otherwise indicated.

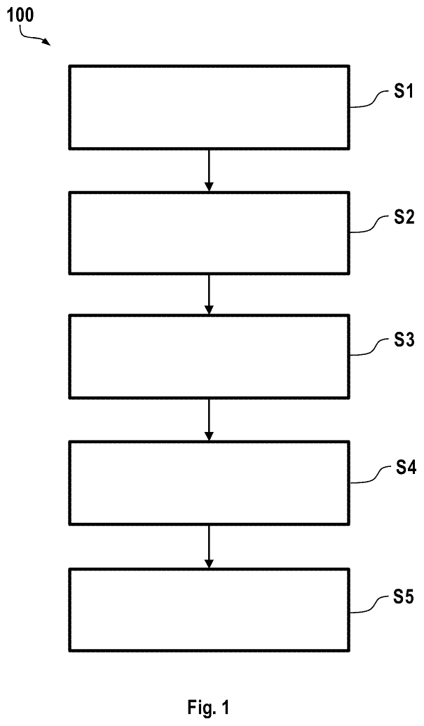

FIG. 1 shows a schematic flow diagram of a method for generating a logic-based evaluation result for an automated subsumption of a life situation, in particular under applicable legal norms.

The method can be executed in any embodiment at least partially by a device 100, which for this purpose can comprise several components not represented in more detail, for example one or more provision devices and/or at least one evaluation and computing device. It is understood that the provision device can be formed together with the evaluation and computing device, or can be different from this. Furthermore, the device 100, which may be part of a system, may comprise a storage device and/or an output device and/or a display device and/or an input device.

The computer-implemented method comprises at least the following steps:

In a step S1, data documenting the life event is provided. This data may include textual, pictorial, natural and/or other evidence that is fed into the device 100, for example via an input device or an interface to external data sources.

In a step S2, the provided data is processed using a machine learning model. This model extracts relevant information from the data and presents it in a structured form. This step can be carried out in the evaluation and computing device, which is connected to the storage device for temporarily storing the extracted information.

In a step S3, a logic network is used to compare the structured information with legal norms and/or requirements. The logic network draws logical conclusions based on the extracted information and the legal requirements. The storage device can be used as a temporary storage for the results of the machine learning model and the logic network.

In a step S4, an assessment of the life situation is carried out by subsuming the extracted information under the applicable legal norms. The results of the logic network are used to generate an evaluation result that includes an assignment of the life situation to the legal norms.

In a step S5, the evaluation result is output, for example via a display device or an external interface. Optionally, information on relevant legal changes or uncertainties can be provided. The output device can also generate reports that present the results and the underlying logical conclusions in detail.

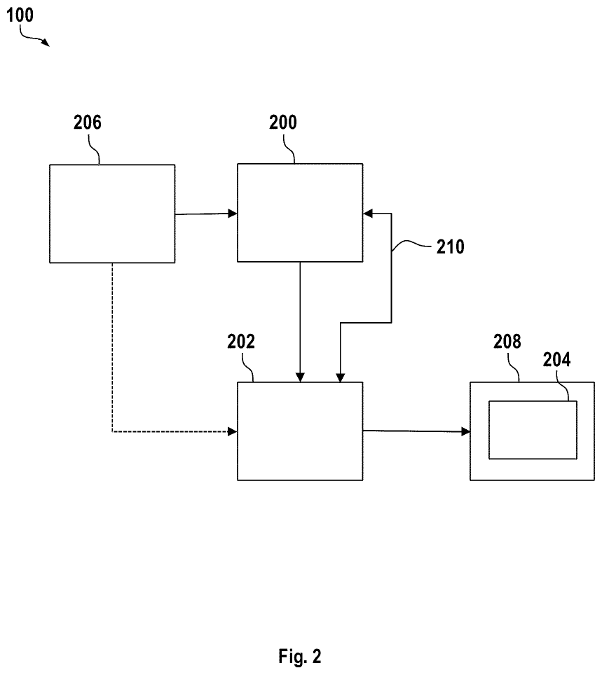

FIG. 2 shows a schematic representation of a machine learning model 200, which is extended by a logic network 202, for generating a logic-based evaluation result 204.

An input block 206 is provided for this purpose, which provides data documenting the facts of the case. This data may include, for example, textual, pictorial, natural and/or other evidence.

The provided data is forwarded to the machine learning model 200. The machine learning model is trained to extract relevant information from the input data and to present it in a structured form. It is also possible for the logic network 202 to access the data from the input block 206 directly.

The structured data is passed to the logic network 202, which draws logical conclusions based on the extracted information and applicable legal standards. The logic network 202 may comprise, for example, a rule-based system, an ontology or a state machine. The logic network 202 processes the data further, taking into account, for example, dependencies and exceptions within the legal norms.

The results of the processing by the logic network 202 are finally presented in an output block 208. The output can include a structured assessment in the form of a report or machine-readable data formats and, if necessary, a logical explanation that makes the derivation steps comprehensible.

The interaction between the machine learning model 200 and the logic network 202 preferably takes place in a bidirectional feedback loop 210. This loop 210 makes it possible to evaluate the relevance of the extracted information and to iteratively refine the processing.

### LIST OF REFERENCES

100 device
200 machine learning model
202 logic network
204 evaluation result
206 input block
208 output block
210 feedback loop
S1 step of providing data
S2 step of processing the data using the machine learning model
S3 step of comparing the data with standards using the logic network
S4 step of evaluating the factual situation by subsumption
S5 step of outputting the evaluation result

1. A method for generating a logic-based evaluation result for an automated subsumption of a factual situation under applicable legal norms, the method comprising the steps of:
providing data documenting the factual situation, the data comprising at least textual, pictorial, natural, and/or other evidence;
processing the provided data using a machine learning model to extract relevant information from the data and to present the extracted information in a structured form;
matching the structured information with legal norms and/or requirements by utilizing a logic network that draws logical conclusions based on the extracted information and the legal requirements;
evaluating the factual situation by subsuming the extracted information under the applicable legal norms based on at least the results of the logic network; and
outputting an evaluation result that includes an assignment of the factual situation to the applicable legal norms.

2. The method of claim 1, wherein the machine learning model comprises a multimodal model configured to process text, images, and/or other evidence simultaneously and provide the data in an integrated, structured representation for subsumption.

3. The method of claim 1, wherein the logic network is based on an ontology that represents legal terms, relationships, and/or hierarchical structures, and supports the subsumption process by semantic inference methods.

4. The method of claim 3, wherein the logic network is dynamically adaptable and/or configured to integrate new rules and/or ontologies automatically based on modifications in legal requirements and/or standards.

5. The method of claim 1, further comprising a feedback loop between the machine learning model and the logic network, wherein the feedback loop iteratively refines the processing of the data by assessing the relevance of the extracted information.

6. The method of claim 1, wherein the logic network uses inference algorithms to account for dependencies and exceptions within the legal norms, enabling a precise evaluation of complex factual situations.

7. The method of claim 1, wherein the evaluation result includes a structured explanation that presents the logical derivation steps between the extracted information and the applicable legal norms.

8. The method of claim 1, wherein the logic network comprises a programmable logic array and/or a state machine, the state machine being configured as a Mealy or Moore structure to execute logical conclusions through state transitions based on the extracted information and legal norms.

9. A computer-readable medium comprising instructions that, when executed by a computing device, cause the device to perform the steps of the method of claim 1.

10. A system for generating a logic-based evaluation result for an automated subsumption of a factual situation under applicable legal norms, the system comprising:
a computing unit configured to:
provide data documenting the factual situation, the data comprising at least textual, pictorial, natural, and/or other evidence;
process the provided data using a machine learning model to extract relevant information and present it in a structured form;
compare the structured information with legal norms and/or requirements using a logic network that draws logical conclusions based on the extracted information and legal requirements;
evaluate the factual situation by subsuming the extracted information under the applicable legal norms based on the results of the logic network; and
output an evaluation result that includes an assignment of the factual situation to the applicable legal norms.
